(19) United States
(12) Patent Application Publication
(10) Pub. No.: US 2002/0154512 A1
(43) Pub. Date: Oct. 24, 2002

(54) Warning light assembly attaching to object without tool

(76) Inventor: Jack Shy, Chang Hua (TW)

Correspondence Address: Jack SHY, 7F, No. 46, Pin Ho 10 Street, Chang Hua, 500, TW

(21) Appl. No.: 09/840,507

(22) Filed: Apr. 20, 2001

(51) Int. Cl. B60Q 1/26

(52) U.S. Cl. 362/503; 362/249; 362/499; 362/504

(57) ABSTRACT

A warning light device includes one or more suckers each having a housing extended from the rear portion for receiving one or more light bulbs. One or more batteries may be coupled to the light bulbs to generate the warning light through the sucker. The light bulbs may be coupled together with electric wires. One or more integrated circuits may be coupled to the light bulbs to energize or to control the light bulbs simultaneously or alternatively. A cover may be engaged onto the housing for retaining the light bulb in the housing of the sucker.

### BACKGROUND OF THE INVENTION

1. Field of the Invention

The present invention relates to a warning light assembly, and more particularly to a warning light assembly for easily attaching onto the objects, such as the windshields of the vehicles, without additional tools.

2. Description of the Prior Art

Typical vehicles or cycles include various kinds of warning light devices that are required to be secured into or onto the vehicles or the cycles with additional tools, and may not be easily attached onto the other objects without additional tools.

The present invention has arisen to mitigate and/or obviate the afore-described disadvantages of the conventional warning light devices.

### SUMMARY OF THE INVENTION

The primary objective of the present invention is to provide a warning light assembly for easily attaching onto the objects, such as the windshields of the vehicles, without additional tools.

In accordance with one aspect of the invention, there is provided a warning light assembly for attaching onto an object, the warning light assembly comprising a plurality of light devices each including a sucker having a housing extended therefrom, at least one light bulb engaged in the housing of each of the light devices to generate a warning light through the sucker, and means for electrically coupling the light bulbs of the light devices together.

One or more batteries may further be provided for energizing the light bulb. One or more integrated circuits may further be provided and coupled to the light bulbs. A cover may further be provided and attached onto the housing for retaining the light bulb in the housing of the sucker.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a plane view illustrating the attachment of a warning light assembly in accordance with the present invention onto a vehicle;

FIG. 2 is a perspective view of the warning light assembly;

FIG. 3 is a partial exploded view of the warning light assembly;

FIG. 4 is a cross sectional view taken along lines 4-4 of FIG. 2;

FIGS. 5 and 6 are partial cross sectional views similar to FIG. 4, illustrating the other applications or embodiments or arrangements of the warning light assembly;

FIG. 7 is a perspective view illustrating the other embodiment of the cover for the warning light assembly; and

FIG. 8 is a perspective view illustrating the other embodiment of the light device for the warning light assembly.

### DETAILED DESCRIPTION OF THE PREFERRED EMBODIMENT

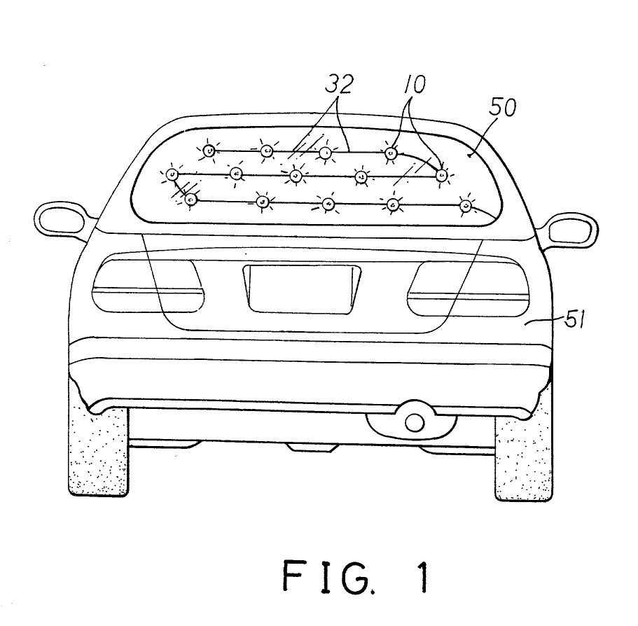

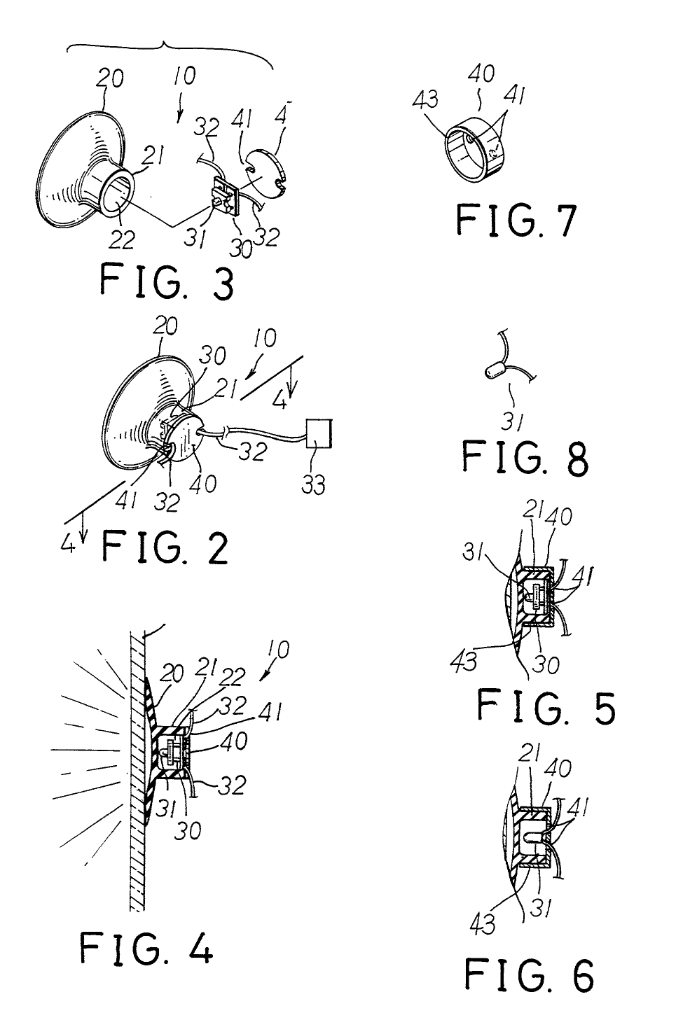

Referring to the drawings, and initially to FIGS. 1-4, a warning light assembly in accordance with the present invention comprises one or more light devices 10 each including a sucker 20 having a cylindrical housing 21 extended therefrom and having a chamber 22 formed in the cylindrical housing 21. The sucker 20 and/or the cylindrical housing 21 of the sucker 20 are preferably made of resilient rubber materials and are preferably transparent for allowing the light to emit therethrough. A cap or a cover 40 may be secured onto the free end or the open end of the cylindrical housing 21, with such as the adhesive materials, or by welding processes, and includes one or more openings 41 formed therein for threading with electric wires 32 or the like.

An integrated circuit 30 and one or more light bulbs 31 are engaged in the chamber 22 of the cylindrical housing 21 and electrically coupled to the electric power source, such as the batteries 33, particularly the batteries of the vehicle 51, with the electric wires 32 which may be extended out of the housing 21 via the openings 41 of the cover 40. The cover 40 may solidly retain the light bulb 31 and/or the integrated circuit 30 within the housing 21 of the sucker 20.

Referring next to FIGS. 5-7, the cover 40 may include a peripheral wall 43 extended or dependent therefrom for solidly engaging onto and securing to the housing 21. As shown in FIGS. 6 and 8, without the integrated circuit 30, the light bulb(s) 31 may be directly engaged into the chamber 22 of the cylindrical housing 21.

In operation, as shown in FIGS. 1, 4, the warning light assembly may include one or more light devices 10 coupled together with the electric wires 32 and coupled to the batteries 33 with the electric wires 32. The light devices 10 may be easily and quickly attached onto the objects, such as the windshield 50 of the vehicle 51 with the suckers 20 without additional tools. The light generated by the light bulbs 31 may emit through the suckers 20 and the windshield 50 for generating a warning signal, when required. The light devices 10 may be controlled or energized simultaneously or alternatively by the integrated circuit 20, or the like.

Particularly, when a car accident is happened in the dark, the light devices 10 may be easily and quickly attached onto the outer peripheral portion of the vehicle for generating the warning lights and for preventing another car accident to be happened.

Accordingly, the warning light assembly in accordance with the present invention may be used for easily attaching onto the objects, such as the windshields of the vehicles, without additional tools.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A warning light device for attaching onto an object, said warning light device comprising:
a sucker including a housing extended therefrom, and
at least one light bulb engaged in said housing of said sucker to generate a warning light through said sucker.

2. The warning light device according to claim 1 further comprising means for energizing said at least one light bulb.

3. The warning light device according to claim 1 further comprising an integrated circuit coupled to said at least one light bulb.

4. The warning light device according to claim 1 further comprising a cover attached onto said housing for retaining said at least one light bulb in said housing of said sucker.

5. A warning light assembly for attaching onto an object, said warning light assembly comprising:
at least one light device including a sucker having a housing extended therefrom, and
at least one light bulb engaged in said housing of said sucker to generate a warning light through said sucker.

6. The warning light assembly according to claim 5 further comprising means for energizing said at least one light bulb.

7. The warning light assembly according to claim 5 further comprising an integrated circuit coupled to said at least one light bulb.

8. The warning light assembly according to claim 5 further comprising a cover attached onto said housing for retaining said at least one light bulb in said housing of said sucker.

9. A warning light assembly for attaching onto an object, said warning light assembly comprising:
a plurality of light devices each including a sucker having a housing extended therefrom,
at least one light bulb engaged in said housing of each of said light devices to generate a warning light through said sucker, and
means for electrically coupling said at least one light bulbs of said light devices together.

10. The warning light assembly according to claim 9 further comprising means for energizing said at least one light bulb.

11. The warning light assembly according to claim 9 further comprising an integrated circuit coupled to said at least one light bulb.

12. The warning light assembly according to claim 9 further comprising a cover attached onto said housing for retaining said at least one light bulb in said housing of said sucker.
